(19) United States
(12) Patent Application Publication
(10) Pub. No.: US 2007/0114765 A1
(43) Pub. Date: May 24, 2007

(54) Foldable wheelbarrow and hand cart

(75) Inventors: David Earl Leger, Chilliwack (CA); Mark Chesley McDonald, Rosedale (GB)

Correspondence Address: JEFFER, MANGELS, BUTLER & MARMARO, LLP, 1900 AVENUE OF THE STARS, 7TH FLOOR, LOS ANGELES, CA, 90067, US

(73) Assignee: Fold-A-Tools Management Inc., Richmond (CA)

(21) Appl. No.: 10/586,228

(22) PCT Filed: Jan. 28, 2005
(86) PCT No.: PCT/CA05/00100

§ 371 Date: Nov. 9, 2006

(30) Foreign Application Priority Data
Jan. 30, 2004 (CA) 2456481

(51) Int. Cl. B62B 1/00

(52) U.S. Cl. 280/653

(57) ABSTRACT

This invention relates to a foldable wheelbarrow and a foldable hand cart. Both comprise a wheel mounting assembly, a leg assembly rotatably connected to the wheel mounting assembly, one or more wheels rotatably connected to the wheel mounting assembly, a collapsible container connected to the wheel mounting and leg assemblies, and at least one support member rotatably connected to both the wheel mounting and leg assemblies and serving to maintain the wheelbarrow in an erected position. The handle members have a pair of handles and a kicker, the kicker has a pair of interconnected longitudinally-extending portions that are each rotatably connected to an associated rear handle segment thereby enabling the handle members to rotate between erected and folded position.

### FIELD OF THE INVENTION

This invention relates to a foldable wheelbarrow and hand cart.

### BACKGROUND OF THE INVENTION

There are many patents disclosing folding wheelbarrows, but to the inventors' knowledge, none of these has been successfully commercially exploited for any length of time. Folding wheelbarrows as shown in the patents can be classified into two main classes, namely those with essentially rigid panel containers, and those with flexible fabric containers. Wheelbarrows having rigid panel containers usually comprise a plurality of essentially rigid sheet panels which are interconnected along edges to form a container mounted on a folding wheelbarrow frame. The rigid panels cannot be folded into a small space similarly to the frame and thus, when folded, occupy considerable space and thus do not provide a compact folding wheelbarrow. Examples of patents relating to folding wheelbarrows with rigid panel containers include U.S. Pat. No. 520,919 (Garver); U.S. Pat. No. 3,552,760 (Sine) and U.S. Pat. No. 3,722,904 (Puckett).

Folding wheelbarrows with flexible fabric containers are usually characterized by a relatively simple lightweight frame, from which a fabric container is suspended. The fabric container has an upper rim which is connected to the frame and thus, for a frame of normal height, volume of the container is limited because walls of the container do not extend upwardly above the frame. The resulting low volume of such wheelbarrows tend to limit their use to relatively light duty applications. Also, usually lower portions of the fabric containers are not connected elsewhere to the frame, and thus the containers are free to swing sideways, particularly when traversing uneven ground or sloping surfaces. Such swinging increases difficulty of controlling the wheelbarrow, particularly when carrying heavy loads. Thus, prior art wheelbarrows with flexible fabric containers would not be appropriate for heavy garden use or industrial applications. Examples of this type of wheelbarrow are found in U.S. Pat. No. 2,494,199 (Provitola et al); U.S. Pat. No. 3,826,511 (Frank) and U.S. Pat. No. 5,222,757 (Magyar).

In contrast with wheelbarrows having flexible containers, wheelbarrows having containers made of essentially rigid panels can have a larger volume similar to conventional non-folding wheelbarrows because upper portions of the panels can extend upwardly above the frame. Also, the rigid panels contribute to rigidity of the container which usually has lower portions securely attached to the frame to reduce relative movement. Thus, such wheelbarrows are generally more suitable for heavy duty use than those with flexible fabric containers, but as previously stated, containers made from rigid panels cannot be folded into a small space due to the relatively large size of the rigid panels. In addition, cost of producing a wheelbarrow with a container made of rigid panels tends to be relatively high compared with costs of manufacturing a folding wheelbarrow with a container of flexible fabric.

Applicant's patents U.S. Pat. Nos. 5,908,202 and 6,017,053 address some of the aforementioned deficiencies in the prior art. These patents disclose a folding wheelbarrow that is adjustable between erected and folded positions and comprises a pair of handle members, a pair of leg members, a wheel and a collapsible container of flexible sheet material. Forward portions of the handle members are hingedly connected together to form a kicker portion when erected, and rear portions of the handle members are laterally spaced apart for gripping when erected. Forward portions of the leg members are hingedly connected together and located above the forward portions of the handle members when erected, and rear portions of the leg members provide spaced apart legs to support the wheelbarrow when erected. Each leg member is hinged to an adjacent handle member for rotation about a respective main hinge axis. The wheel is mounted for rotation about a transversely extending axle which is hingedly and slidably connected to the forward portions of the handle members. The collapsible container is made of a flexible sheet material and is located between the forward portions of the leg members and the rear portions of the handle member. A stiffening structure extends between the handle members and the leg members to limit relative movement therebetween about the main axis to stiffen the wheelbarrow when erected.

### SUMMARY OF THE INVENTION

It is an object of the invention to provide a wheelbarrow and hand cart that reduce the difficulties and disadvantages of prior art wheelbarrows and hand carts, and in particular, to provide a folding wheelbarrow and hand cart with a collapsible container of flexible fabric which can be erected to provide a container having a volume approximately equal to that of the conventional domestic wheelbarrow or hand cart, and yet can be easily collapsed into a smaller volume, thereby facilitating convenient handling, transportation and/or storage.

According to one aspect of the invention, there is provided a foldable wheelbarrow comprising a foldable frame, a wheel mounted to the frame, and a foldable container mounted to the frame. The frame comprises a wheel mounting assembly and a leg assembly rotatably connected to each other such that the frame can be rotated between an erected position and a vertically folded position. The wheel mounting assembly has a pair of handles and a kicker; the kicker has a pair of interconnected longitudinally-extending members that are each rotatably connected to an associated handle such that the handles are rotatable between handle erected and handle folded positions. The leg assembly has a pair of interconnected longitudinally-extending support members that are each rotatably connected to the kicker and rotatable between leg erected and leg folded positions. The frame also includes locking means for locking the handles in the erected position and at least one frame support member that are each rotatably connected to one handle and to the leg assembly, such that rotation of the connected handle causes the leg assembly to rotate relative to the wheel mounting assembly and locking the handle in the handle erected position causes the leg assembly to lock in the leg erected portion. The wheel is rotatably mounted to the wheel mounting assembly; and the foldable container is mounted to the frame such that the container is erected when the leg assembly is in the leg erected position, and folded when the leg assembly is in the leg folded position.

This design is particularly advantageous as the support member and locking means cooperate to secure the wheelbarrow frame in the erected position without assistance from the container. Therefore, the container does not need to act as stiffening member for the frame.

The locking means can comprise a pair of hinging plates each respectively mounted to one of the handles and to one of the kicker members. The hinging plates each have slots that align when the handle is in the handle erected position. The locking means also include a lockout member engagable with the aligned slots to lock the plates in place.

The container can be connected at a front end to the leg members and at a rear end to at least one handle such that rotation of the handles between the handle erected and folded positions cause the container to move between container erected and folded positions. The longitudinally-extending kicker members can be interconnected by a pair of transversely-extending members rotatably connected together such that the wheel mounting assembly is rotatable between a laterally erected position and a laterally folded position. Similarly, the leg longitudinally-extending leg members can be interconnected by a pair of transversely-extending members rotatably connected together such that the leg assembly is rotatable between a laterally erected position and a laterally folded position.

The handles and kicker members can be rotatably connected by a pair of hinging devices. Each hinging device can comprise a pair of hinging plates each mounted to a respective handle and kicker member and rotatably connected to each other. The two hinging plates each have slots that align when the handle is in the erected position. Each hinging device further has a lockout member that is engagable with the slots to lock the associated handle in the handle erected position.

The wheelbarrow can further include a transverse stiffener having left and right portions that are each rotatably connected to an associated handle and rotatably connected to each other, such that the stiffener is rotatable between a transversely-extending erected position that moves the wheel mounting and leg assemblies into the laterally erected positions, and a folded position that moves the wheel mounting and leg assemblies into the laterally folded positions. The lock-out member for each handle hinging device can be attached to a location on the stiffener that causes the lockout member to engage the associated handle hinging device when the stiffener is in its erected position, and to disengage the associated handle hinging device when the stiffener is in its folded position.

According to another aspect of the invention, there is provided a foldable hand cart that comprises a foldable frame, a pair of wheels mounted to the frame and a foldable container mounted to the frame. The frame comprises a wheel mounting assembly having a handle portion with a pair of interconnected longitudinally-extending members and a wheel mounting portion with a pair of interconnected longitudinally extending members. Each wheel mounting member is rotatably connected to an associated handle member such that the handle portion is rotatable between handle erected and handle folded positions. The frame also comprises a leg assembly having a pair of interconnected longitudinally-extending support members each rotatably connected to the wheel mounting portion and rotatable between leg erected and leg folded positions. The frame also comprises locking means for locking the handle portion in the erected position; and at least one frame support member each rotatably connected to handle portion and to the leg assembly, such that rotation of the handle portion causes the leg assembly to rotate relative to the wheel mounting assembly and locking the handle portion in the handle erected position causes the leg assembly to lock in the leg erected portion. The pair of wheels are rotatably mounted to the wheel mounting portion; and the foldable container is mounted to the frame such that the container is erected when the leg assembly is in the leg erected position, and folded when the leg assembly is in the leg folded position.

### BRIEF DESCRIPTION OF THE DRAWINGS

FIGS. 1-4 are simplified side elevation, top plan, front elevation and rear elevation views of a foldable wheelbarrow according to one embodiment of the invention with a wheelbarrow frame shown in an erected position.

FIGS. 5 and 6 are simplified side elevation and top plan views of the wheelbarrow frame in a folded position.

FIG. 7 is a simplified perspective detail view of a handle hinging device for the foldable wheelbarrow.

FIG. 8 is a simplified perspective detail view of a stiffener for the foldable wheelbarrow shown in an erected position.

FIG. 9 is a simplified perspective detail view of the stiffener of FIG. 8 shown in a folded position.

FIGS. 10-12 are simplified side elevation, top plan, and front elevation views of a foldable hand cart according to second embodiment of the invention with a cart frame shown in an erected position.

FIGS. 13-15 are simplified side elevation, top plan, and front elevation views of the hand cart frame shown in a folded position.

### DETAILED DESCRIPTION OF EMBODIMENTS OF THE INVENTION

Directional terms such as “vertical”, “horizontal”, “top” and “bottom” are used in the following description for the purpose of providing relative reference only, and are not intended to suggest any limitations on how any apparatus is to be positioned during use, or to be mounted in an assembly.

Foldable Wheelbarrow

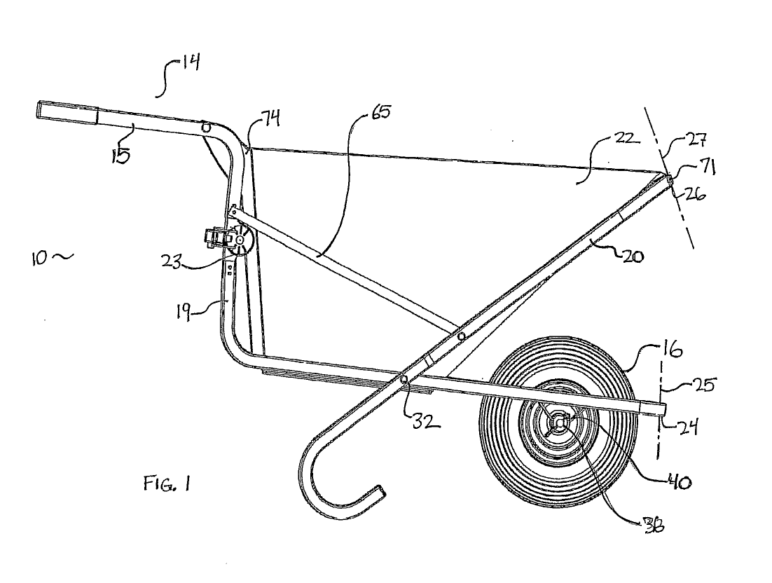

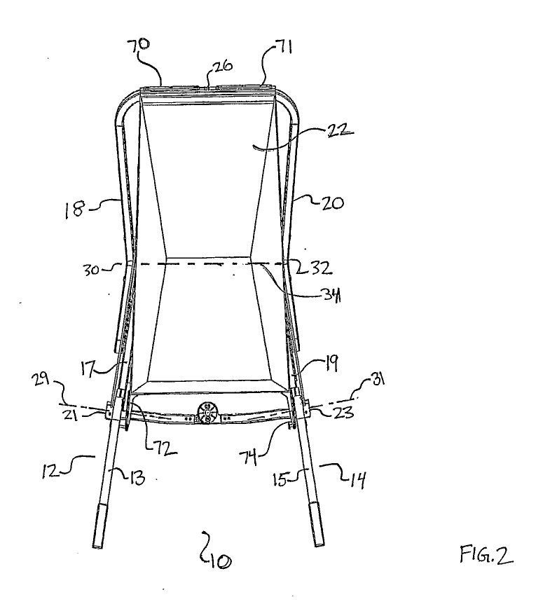

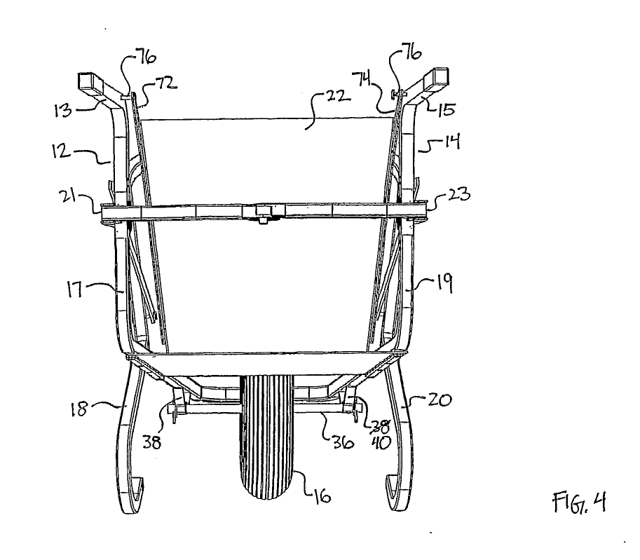

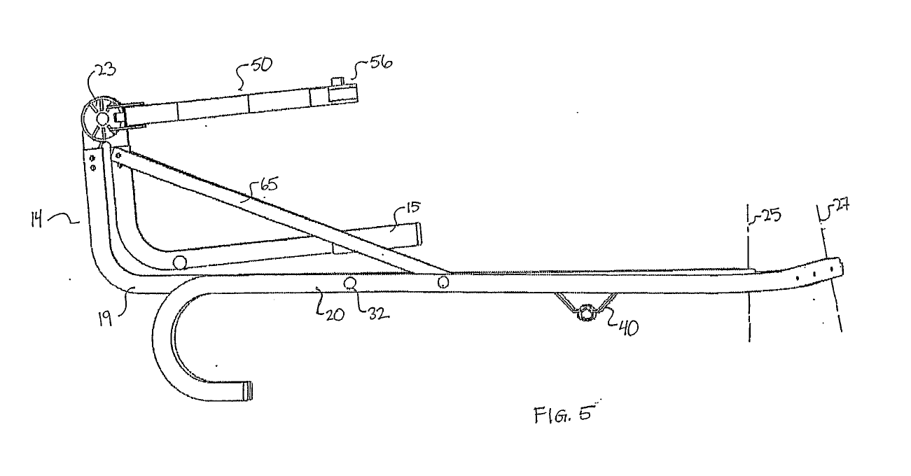

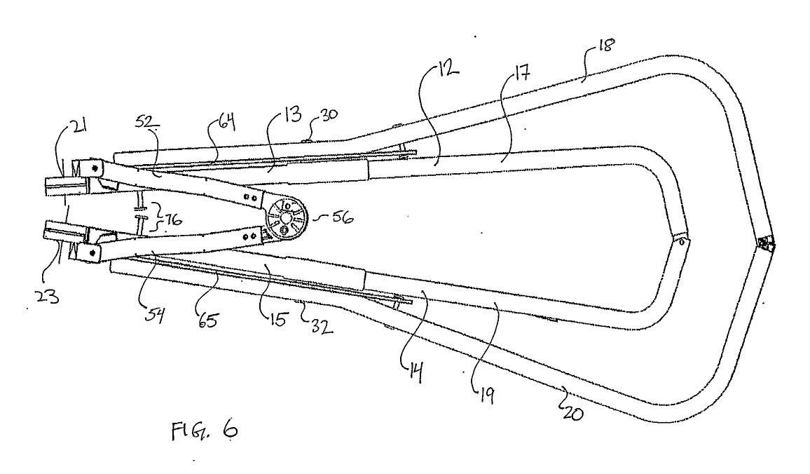

According to a first embodiment of the invention, a foldable wheelbarrow 10 is shown in an erected position in FIGS. 1-4 and in a folded position in FIGS. 5-6. The wheelbarrow 10 has a wheel mounting assembly comprising left and right handle members 12 and 14, and a wheel 16 mounted to the front bottom of the handle members 12, 14 for rotation with respect to the handle members 12, 14. The wheelbarrow 10 also has a leg assembly comprising left and right leg members 18 and 20 rotatably connected to the handle members 12, 14. The handle and leg members 12, 14, 18 and 20 together define a wheelbarrow frame, and are made of tubes of metal or another suitable material which provide portions of a light and strong collapsible frame. The wheelbarrow 10 also has a flexible collapsible container 22 made of pliable sheet material attached to the frame.

The handle members 12, 14 each have a left and right handle segment 13, 15 and a left and right front kicker segment 17, 19. When the wheelbarrow 10 is erected and resting on level ground, the front kicker segments 17, 19 each have a longitudinal central portion that extends substantially horizontally, a longitudinal rear end that curves upwardly from the central portion, and a transverse front end that curves horizontally inwardly from the central portion. Also, the rear handle segments 13, 15 each have a rear grasping portion that extends substantially horizontally and a front end that curves downwardly from the grasping portion.

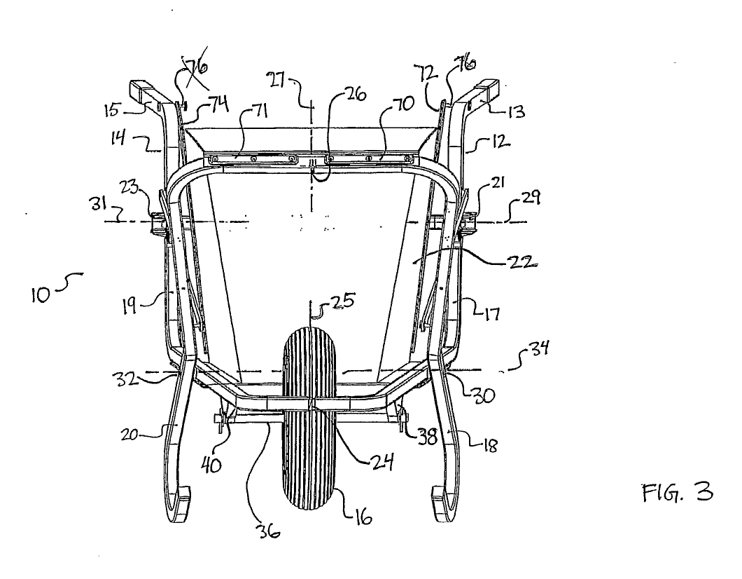

Referring particularly to FIG. 3, the front end of each front kicker segment 17, 19 is rotatably connected by a first vertical hinge pin 24, which defines a first, generally vertically-extending axis (“handle vertical axis”) 25 and enables the handle members 12, 14 to move between a laterally folded and a laterally erected position. When the wheelbarrow 10 is in its laterally erected position, the front kicker segments 17, 19 form a kicker portion which extends partially and forwardly around the wheel 16 and functions as a conventional kicker of a conventional rigid wheelbarrow, and the grasping portion of the handle members 12, 14 are laterally spaced apart at a distance that is convenient for grasping by a user. When folded about the handle vertical axis 25, the grasping portions of the handle members 12, 14 are drawn laterally inwards. The design and operation of the folding of the handle members 12, 14 about the handle vertical axis 25 is known in the art, and for example, is disclosed in applicant's U.S. Pat. No. 5,908,202.

The rear end of each front kicker segment 17, 19 is rotatably connected to the front end of an associated rear handle segment 13, 15 by respective left and right handle hinging devices 21, 23, that enable each front and rear handle segment 13, 15, 17, 19 to rotate about a respective left and right transversely-extending axis (“left and right handle transverse axes”) 29, 31, and between erected and folded positions. Details of folding of the handle and kicker segments 13, 15, 17, 19 about the handle transverse axes 29, 31 are described below.

The leg members 18, 20 have respective forward and rear portions. The forward portions of the leg members 18, 20 curve transversely inwards and are rotatably connected together with a second vertical hinge pin 26, which defines a second generally vertically-extending axis (“leg vertical axis”) 27. The rear portions of the leg members 18, 20 extend longitudinally to provide a base for supporting the erected wheelbarrow 10. The second vertical hinge 26 is located generally above the first hinge 24 when the wheelbarrow 10 is erected, and enables the leg members 18, 20 to rotate about the leg vertical axis 27 between a laterally erected position wherein the rear portions of the leg members 18, 20 are laterally spaced apart, and a laterally folded position wherein the rear portions of the leg members 18, 20 are drawn laterally inwards. The design and operation of the folding of the leg members about this leg vertical axis 27 is known in the art, and for example, is disclosed in applicant's U.S. Pat. No. 5,908,202.

The leg members 18 and 20 are located outwardly of and are hinged to adjacent handle members 12 and 14 respectively for rotation about respective left and right horizontal hinge pins 30 and 32. In particular, sleeves (not shown) are located through the central portion of each front kicker segment 17, 19 and through a central portion of each leg member 18, 20; each horizontal hinge pin 30, 32 extends through the sleeves in associated kicker and leg members, 17, 19, 18, 20. When the wheelbarrow 10 is in the erected position, the horizontal hinge pins 30 and 32 are disposed on a second transversely-extending axis (“frame transverse axis”) 34 and thus are aligned with each other. The frame transverse axis 34 provides an axis about which the members 12, 14, 18 and 20 of the frame can rotate between a vertically erected and a vertically folded position. As can be seen in FIGS. 5-6, the handle and leg members, 12, 14, 18, 20 are in substantially the same horizontal plane when folded.

The wheelbarrow 10 has a transversely-extending wheel axle 36 extending between the forward portions of the handle members 12 ,14, and the wheel 16 is mounted for rotation about the axle 36. The axle 36 is positioned so that the wheel 16 is located adjacent and rearward of the kicker portion and is selected so that the kicker portion will contact the ground to move the wheel 16 off the ground when a load is being dumped forwardly from the container 22 following conventional practise. As best seen in FIG. 3, the axle 36 comprises a central portion journalling the wheel 16, and right and left axle end portions extending outwardly from the central portion and slidably received in respective left and right axle supports 38, 40. The supports 38, 40 extend generally vertically upwardly from the axle end portions and attach to the front handle members 12, 14, such that the axle 36 is located between and suspended below the handle members 12, 14. The front handle members 12, 14 have openings (not shown) provided with journals to receive and journal the respective axle supports 38 and 40 to permit limited rotation of each handle member 12, 14 relative to the respective axle end portion which occurs when the frame folds about the vertical hinges 24 and 26. The axle supports 38 and 40 also slide laterally relative to the axle 36 and thus, the axle 36 is slidably connected to forward portions of the respective handle members 12, 14 to permit limited sliding of each handle member 12, 14 with respect to the axle 36.The design and operation of the axle 36 and axle supports 38, 40 are known in the art, and for example, is disclosed in applicant's U.S. Pat. No. 5,908,202.

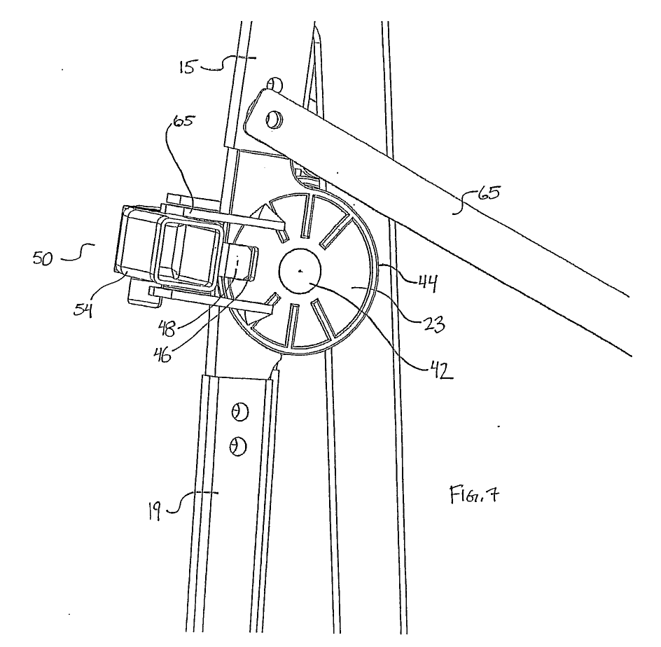

Referring now to FIGS. 7-9, the handle hinging devices 21, 23 operate to rotate the handle and kicker segments 13, 15, 17, 19 between a folded position as shown in FIGS. 5-6, and an erected position, as shown in FIGS. 1-4. Each handle hinging device 21, 23 has a hinge pin 42 that extends through a pair of opposed hinge plates 44, wherein an outer hinge plate 44 is attached to the rear handle segment 13, 15, and an inner hinge plate 45 is attached to the front kicker segments 17, 19. A slot 46 is provide through each hinge plate 44, 45; the slots 46 line up when the handle members 12, 14 are in the erected position. When the slots 46 are lined up, they form a rearwardly-facing recess that can receive a lock-out member 48. When each lock-out member 48 is inserted into the respective slot 46 of each handle hinging device 21, 23, the handle hinging devices 21, 23 are prevented from rotating, and thus the handle members 12, 14 are fixed in their erected position. The use of such lock-out members 48 has been found to be particularly suitable to conveniently lock the handle members 12, 14 in place and to withstand the substantial shear forces found at the hinging devices 21, 23 when the wheelbarrow 10 is loaded, and in particular, has been found to be more suitable than conventional lock-out pins that are inserted through a pair of conventional hinge plates. However, a lock-out pin (not shown) can be used instead of the lock-out member, provided that the pin is designed to withstand the typical forces encountered at the hinging devices 21, 23. In such case, a hole is provided through both hinging plates 44, 45 to receive the lock-out pin, instead of the slot 46.

When the lock out members 48 are removed from the slots 46, the handle hinging devices 21, 23 are free to rotate, and the handle members 12, 14 can thus rotate between their erected and folded positions. The lock out members 48 are made of steel or another similar material that is capable of withstanding the local shear forces.

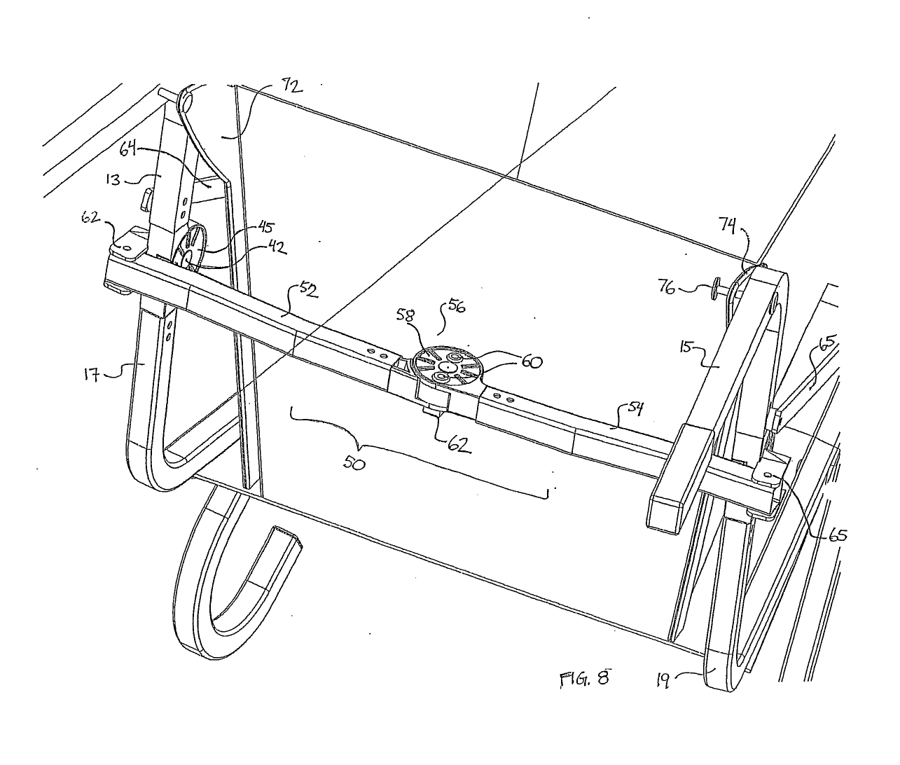

The lock out members 48 are attached to the ends of a transverse stiffener 50. As best seen in FIG. 8, the stiffener 50 comprises left and right members 52, 54 and a stiffener hinging device 56 rotatably connecting the two members 52, 54 together. Like the handle hinging devices 21, 23, the stiffener hinging device 56 has a pair of opposed hinging plates 58, each respectively attached to the inside end of one of the left and right members 52, 54. Extending through each hinging plate 58 are a pair of lock-out holes 60; the lock-out holes 60 in each hinging plate 58 line up when the stiffener 50 is in an erected position, i.e. when the members extend transversely along the same axis. A lock out pin (not shown) can be inserted inside one of the lined up lock-out holes 60 to secure the stiffener 50 in the erected position. The pin is spring loaded and can be released by a lever 62 mounted to the bottom of the stiffener hinging device 56. The pin can engage both holes 60 at approximately 180 degrees. A spring encircles the pin and is loaded by a locking washer that is attached to the pin. When the lever 62 is either pushed or pulled, a cam on the end of the lever 62 gives rise and pulls the pin. When the pin is pulled, it disengages itself from the hole 62 in one of the hinge plates 58. When the two hinge plates are rotated relative to each other, the pin rides along the inner portion of the hinge plate 58 until it finds the other hole 62, and can then be inserted therein.

Optionally, the stiffener hinging device can use the slot and lock-out member design as used for the hinging devices 21, 23.

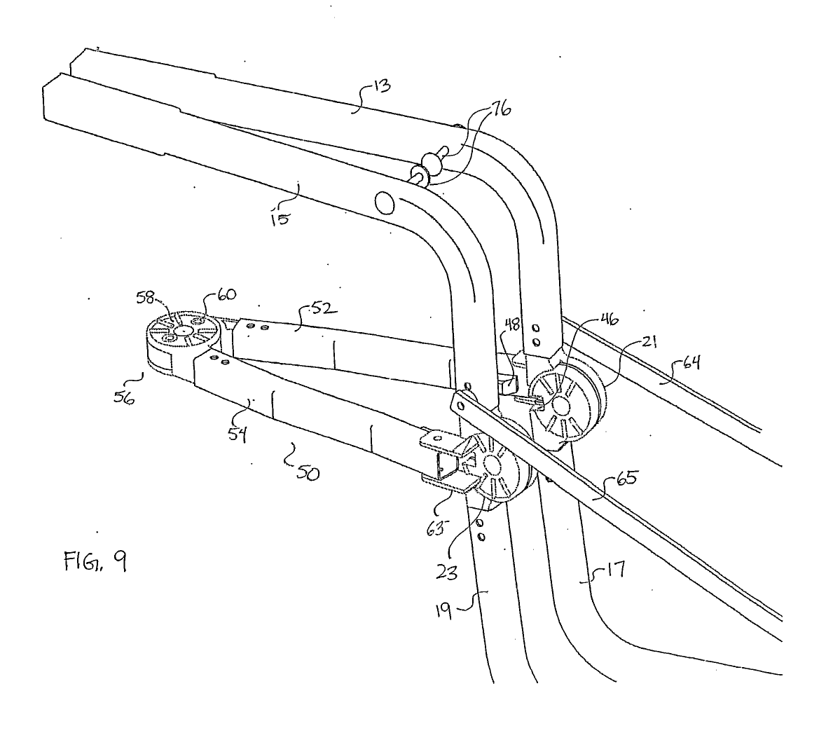

The outer end of each left and right member 52, 54 are rotatably connected to associated left and right brackets 62, 63, which in turn are each attached to the outer hinge plate of associated left and right hinging devices 21, 23. This enables the stiffener 50 to rotate between an erected position wherein the left and right members 52, 54 are aligned along the same transverse axis, and a folded position, wherein the left and right members 52, 54 extend rearwardly to form a “V” shape and the handle and leg members 12, 14, 18, 20 are brought laterally close together (as shown in FIG. 9).

Referring again to FIG. 7, the lock out members 48 are attached to the outer ends of each stiffening member 52, 54 such that when the handle members 12, 14 are in their erected position, the stiffener 56 can be rotated into its erected position, and the lock out members 48 can be conveniently inserted into the slots 46 to lock the handle members 12, 14 in place. When the stiffener 56 is in its erected position, the lock out pin can be inserted into the lock out holes 60 to lock the stiffener in place, which serves to lock the handle members 12, 14 in their erected positions about both the handle vertical and transverse axes, and to lock the leg members 18, 20 in their erected positions about the leg vertical axis.

It is important that the handle members 12, 14 and the leg members 18, 20 are locked when the wheelbarrow 10 is erected and do not unintentionally fold from the erected position, either about the handle and leg vertical axes 25, 27 nor about the handle and frame transverse axes 29, 31 34. As mentioned, the stiffener 50 serves to lock the handles 12, 14 in place to prevent folding about the handle transverse axes 29, 31, as well as to prevent the wheelbarrow folding about the leg and handle vertical axes 25, 27. A pair of frame support members, namely left and right frame support members 64, 65 are provided to enable the stiffener 50 to lock the frame in place, i.e. to prevent the leg and handle members, 12,14,18, 20 from rotating about the frame transverse axis 34. Furthermore, and as will be described in detail below, the attachment of the container 22 to the frame helps to prevent the frame from collapsing into its folded position.

The left and right frame support members 64, 65 are each rotatably connected at one end to the downwardly extending portion of an associated rear handle segment 13, 15, and at the other end to an associated leg member 18, 20. The rotatable connections are conventional, and for example are provided by suitable hinge pins extending through suitably placed holes in the handle and leg members 12, 14, 18, 20 and support members 64, 65. The location of the holes on the handle and leg members 12, 14, 18, 20 is calculated to enable the support members 64, 65 to move the leg members 18, 20 into their folded position (i.e. in substantially the same horizontal plane as the front handle members 17, 19) when the rear handle members 13, 15 are rotated about the handle transverse axes 29, 31 from an erected position into a folded position.

Referring again to FIGS. 1 to 3, the flexible container 22 extends longitudinally between the forward portions of the leg members 18, 20 and the rear portions of the handle members 12, 14 and laterally between the handle and leg members 12, 14, 18, 20. The container 22 is made of a tough but flexible sheet material, such as a reinforced, impermeable, polymer coated (PVC), synthetic fibre (Nylon) woven material of about 28 oz per square yard, sold under the name Shelterite XR-5, a trade-mark of Seaman Corporation of Ohio, U.S.A. Such material can be joined together or bonded using ultrasonic welding techniques, although other material which can be bonded using adhesives can be substituted. Alternatively, the material can be sewn together or connected using other fastening means. The material should be sufficiently flexible to permit folding of the wheelbarrow under normal temperatures, and yet be sufficiently tough to withstand loading with normal garden material, such as soil, rocks, garden refuse, etc. In addition, the material should be sufficiently abrasion resistant to withstand grating with a shovel, and repeated, highly loaded abrading against portions of the wheelbarrow frame.

The container 22 has left hand and right hand side panels, forward and rear panels, and a bottom panel interconnecting the bottom edges of the side, forward and rear panels to form a polygonal prism shape which resembles a conventional domestic wheelbarrow container or box. The container 22 also has a volume generally similar to a prior art wheel barrow for example approximately 5-6 cubic feet.

The container 22 is attached to the frame by left and right front flanges 70, 71 left and right rear flanges 72, 74, and left and right bottom flanges (not shown). The left and right front flange 70 are both transversely-extending members bent at about a 90 degeee angle along its length. The left front flange 70 is attached to the left front lip of the container 22 and to the front transverse portion of the left leg member 18; similarly, the right front flange 71 is attached to the right front lip of the container 22 and to the front transverse portion 20 of the right leg member. The fastening is made by bolts through associated holes in the flanges 70, 71, container 22, and leg members 18, 20; however, any other suitable means of fastening can be substituted. The left and right bottom flanges attach to the container bottom 22 and the front kicker segments 17,19 in a similar manner as the front flanges 70, 71.

The left and right rear flanges 72, 74 are each L shaped members having a long leg and a short leg, and are attached at their long leg to the rear vertical edges of the container 22, i.e. at the edges defined by the rear container panel and the left and right container panels. The short leg of each flange 72, 74 extends upwardly and rearwardly and is provided with a hole that aligns with a corresponding hole in the associated left and right rear handle segment 13, 15. A hinge pin 76 extends through these aligned holes, and enables the rear handle segments 13, 15 to fold about the handle transverse axes 29, 31 while the container 22 collapses into its folded position.

When the wheelbarrow 10 is erected, intermediate portions of the handle members 12 and 14 are disposed at the angle of about 35 degeees to the leg members 18 and 20 and are held in place by the erected stiffener 50. In order to fold the wheelbarrow 10 from the erected position into its folded position, the lever 62 on the stiffener hinging device 56 is moved to release the lockout pin from the holes 60 of the hinging plates 58. The stiffener 50 is then rotated from its erected position, into a rearwardly extending folded position, which causes the handle and leg members 12, 14, 18, 20 to fold laterally about their respective handle and leg vertical axes, and to cause the container 22 to collapse laterally inwards therebetween.

The folding of the stiffener 50 also serves to lift the lock-out members 48 out of their associated slots 46 in the left and right hinging devices 21, 23, thereby enabling the handle members 12, 14 to fold vertically about the handle transverse axes 29, 31. As the rear handle segments 13, 15 are folded into the wheelbarrow 10 (i.e. clockwise when viewing the right profile of the wheelbarrow 10), the support members 64, 65 cause the leg members 18, 20 to rotate about the frame transverse axis 34 so that the front ends of the leg members 18, 20 move downwards. The rear handle segments 13, 15 are rotated about 180 degeees until they are substantially parallel to the front kicker segments 17, 19. The location of the hinges for the support members 64, 65 cause support members 64, 65 to force the leg members into a folded position that is substantially in the same plane as the front handle kicker 17, 19 when the rear handle segments 13, 15 are folded 180 degeees.

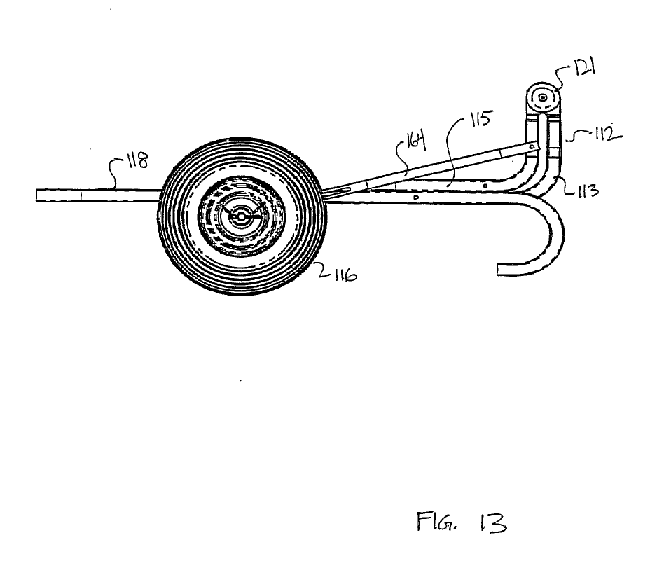

As the handle members 12 and 14 and the leg members 18 and 20 move inwardly towards each other, the axle sleeves 38, 40 slide inwardly along the axle 36. During this folding, the fabric of the container 22 is manipulated to position it so that the wheel 16 displaces the fabric of the forward panel and bottom panel upwardly to permit the forward portions of the handle and leg members 12,14, 18, 20 to approach each other and contact each other as shown in FIG. 13, with a displaced bottom portion of the container 22 enclosing an upper periphery of the wheel 16. This is possible due to the fabric fullness provided in the container 22 due to the broad flap portions of the bottom corner connectors.

In the folded position, the wheelbarrow can be stored easily, for example by hanging against a wall with the wheel at a lowermost position. When folded, the wheelbarrow can be carried easily in the trunk of a car, or in a lockable transverse cargo box of a light pick-up truck, or several can be carried on the back of a pick-up truck.

To erect the wheelbarrow 10 from the folded position, the folded wheelbarrow 10 is first placed on the ground with the foot pads and the wheel 16 supporting the folded wheelbarrow 10. The handle members 12, 14 are gripped and rotated first about the transverse handle axes 29, 31 so that the rear handle segments 13, 15 rotate upwards and rearwards. This causes the support members 64, 65 to pull the leg members 18, 20 upwards, which unfurls the container 22. Since the container 22 is fastened to the rear handle segments 13, 15, the upwards rotation of the rear handle segments 13, 15 places tension on the container 22, which in turns places tension on the leg members 18, 20, thereby contributing to the deployment of the leg members 18, 20 into an erected position. When the rear handle segments 13, 15 are fully rotated into their erected positions, the container 22 serves to apply tension to the erected leg members 18, 20 which causes them to stay in their erected positions.

When the handles have been fully rotated and are facing substantially rearwards, the stiffener 50 is moved into its erected position; this causes the handle and leg members 12, 14, 18, 20 to rotate outwards until they reach the erected positions. When the stiffener 50 reaches its erected position, it causes the handle and leg members 12, 14, 18, 20 to reach their respective erected positions and the lock-out members 48 to be inserted into the corresponding slots 46 of the handle hinging devices 21, 23. The lock pin can then be inserted in the stiffener hinging device 56 to lock the stiffener 50, and by extension the frame, in the erected position.

The wheelbarrow 10 described above is foldable about the handle and leg vertical axes as well as about the handle and frame transverse axes and thus is particularly desirable because it can fold into an extremely compact form. However, it may be desirable to provide a less complex (and thus less expensive) wheelbarrow (not shown) in which only the handle members 12, 14 are foldable about the handle transverse axes. According to an alternative embodiment of the invention, there is provided a foldable wheelbarrow in which the left and right handle members and left and right leg members are rigidly fixed together, i.e. are not rotatable about the handle and leg vertical axes, and the leg members are rigidly fixed to the kicker portion of the handle members. In such case, the leg members can instead be a single member that is bent into a U-shape, and the kicker portion can be a single member also bent into a U-shape. Such a wheelbarrow does not require the side support members and can be provided with a rigid container as the wheelbarrow will not fold laterally or vertically inwards. Alternatively, the wheelbarrow can have handle members foldable about the handle transverse axes and also be foldable about one of (a) the handle and leg vertical axes, or (b) the frame transverse axis. In case (a), the left and right kicker portions are rotatably connected together and the left and right leg members are also pivotably connected together in the same manner as described above. In case (b), the leg members are pivotably connected to the kicker portion in the same manner as described above.

Hand Cart

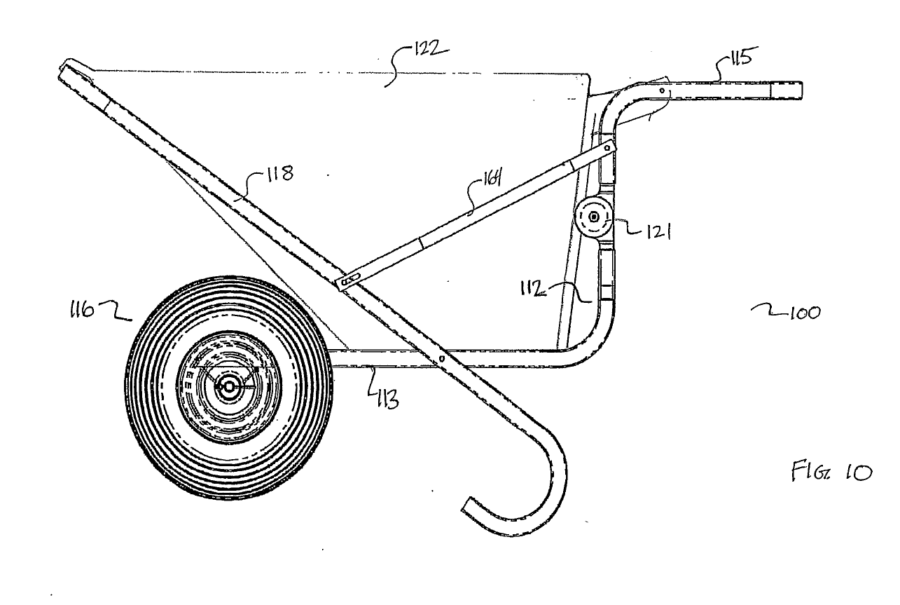

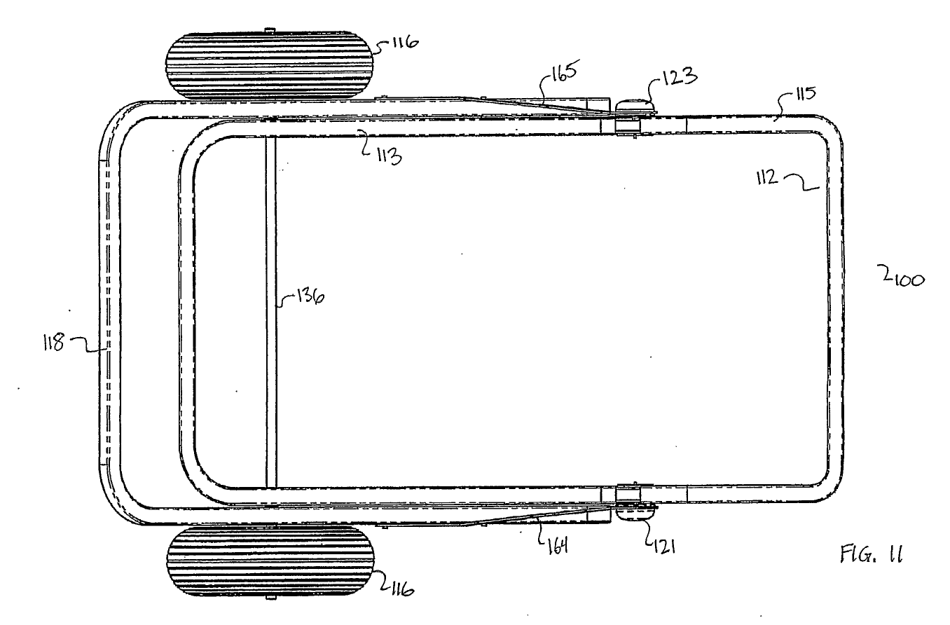

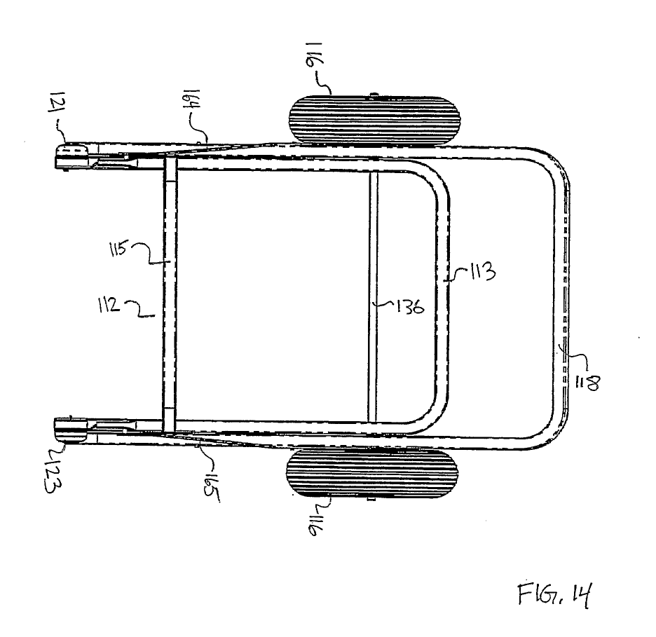

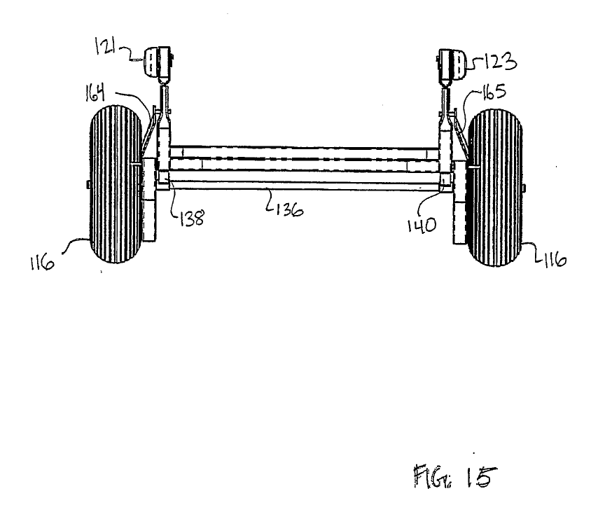

According to another embodiment of the invention, and referring to FIGS. 10-15, there is provided a foldable hand cart 100 that, like the foldable wheelbarrow 10, is foldable between an erected position as shown in FIGS. 10-12 and a folded position as shown in FIGS. 13-15.

The foldable hand cart 100 in most respects is the same as the foldable wheelbarrow 10 except of course, that the hand cart 100 has a pair of transversely spaced wheels 116 rotatably mounted to the front bottom portion of a wheel mounting assembly 112. The wheel mounting assembly 112 comprises a U-shaped front wheel mounting segment 113 and a U-shaped rear handle segment 115 rotatably joined together by respective left and right hinging devices 121, 123. In particular, when the cart 100 is in an erected position, the rear ends of the wheel mounting segment 113 curve generally upwards and the front ends of the rear handle segment 115 curve generally downwards. These wheel mounting and handle segments 113, 115 are attached to the left and right hinging devices 121, 123 in the same manner as described for the foldable wheelbarrow 10. The hinging device 121 can be a conventional hinge as shown in FIGS. 10-15 with a lock-out pin (not shown), or be the same design as in the foldable wheelbarrow 10, i.e. be slotted to receive a lock-out member (not shown).

The hand cart also includes a U-shaped leg member 118 that is rotatably connected to the wheel mounting assembly 112 at the wheel mounting segment 113. The ends of the leg member 118 are curved and serve as base on which the hand cart 100 can be rested when in the erected position. The handle and leg members 112, 118 together form a hand cart frame to which is attached a flexible container 122. The container 122 can be the same container as described in the foldable wheelbarrow 10. The rotatable connection between the wheel mounting assembly 112 and the leg member 118 can be the same as described in the foldable wheelbarrow 10, and thus define a transverse frame axis around which the wheel mounting assembly and frame members 112, 118 can rotate.

A left and right frame support member 164, 165 is hingedly connected to the leg member 118 and the rear handle segment 115, and operates to move the leg member 118 between a folded position when the rear handle segment 115 is folded, and an erected position when the rear handle segment 113 is erected. The frame support members 164, 165 are rotatably connected to the left and right arms of the rear handle segment 115 and to the left and right legs of the leg member 118 in the same manner as described in the foldable wheelbarrow 10.

The support members 164, 165 act as a spring between the folded and erected positions. When folding the cart 100 and rotating the handle segment 113, the support member 164, 165 bows slightly and snaps the handle segment 113 into the folded position once it has passed by the maximum compression point.

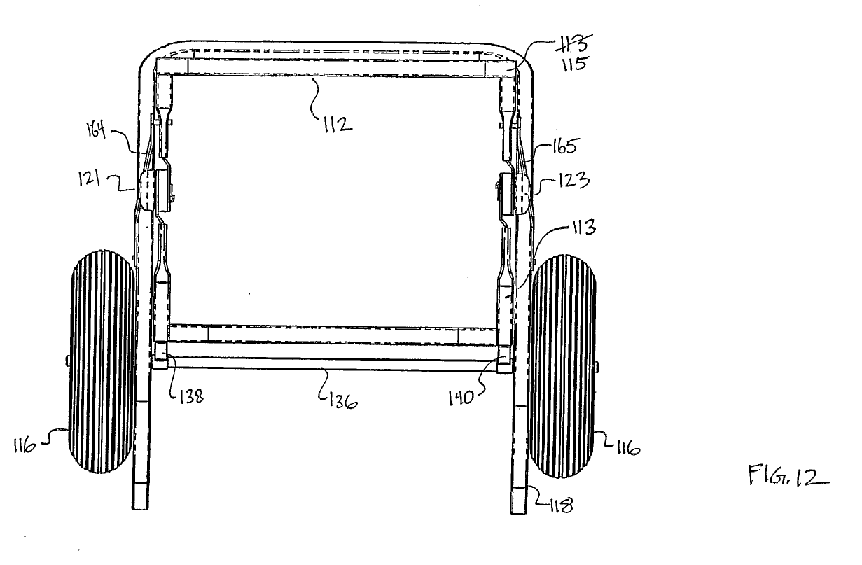

The cart 100 has a transversely extending wheel axle 136 extending between the arms of the wheel mounting segment 113 and the wheels 116 are mounted at each end of the axle 136 outside the frame, for rotation about the axle 36. As best seen in FIG. 12, the axle 136 comprises a central portion journalling the wheels 116, and right and left axle end portions extending outwardly from the central portion and slidably received in respective left and right axle supports 138, 140. The supports 138, 140 extend generally vertically upwardly from the axle end portions and attach to the left and right arms of the wheel mounting segment 113, such that the axle 36 is suspended below the wheel mounting assembly 112 and the wheels are located on the outside of the frame. Sufficient clearance is provided between each wheel 116 and the adjacent arm of the wheel mounting segment 113, to enable the leg member to fold flat in between the wheels 116 and the wheel mounting assembly 112, such that when the cart 100 is in the folded position, the wheel mounting assembly and leg members 112, 118 are substantially in the same plane.

The hand cart can be changed from its erected position to its folded position by first removing the lock-out pins from the left and right hinging devices 121, 123. This enables the rear handle segment 115 to rotate about a transverse handle axis defined by the hinging devices 121, 123. The rear handle segment 115 is then rotated 180 degeees towards the cart, i.e. upwards then forwards. As the rear handle segment 115 is being rotated, the support members 164, 165 cause the leg members to also rotate in the same direction, around the transverse frame axis. The container 122 collapses in the same manner as described for the foldable wheelbarrow 10.

When the rear handle segment has reached its folded position, the support members 164, 165 will have moved the leg member 118 into a folded position that is generally in the same horizontal plane as the wheel mounting segment 113. The container 122 will also have collapsed and occupies significantly less volume than when erected. When folded, the hand cart 100 has a much more compact form that allows it to be easily transported.

While the preferred embodiments of the invention have been illustrated and described, it will be appreciated that various changes can be made therein without departing from the scope and spirit of the invention.

What is claimed is:

1. A foldable wheelbarrow comprising:
a frame comprising
a wheel mounting assembly having a pair of handles and a kicker, the kicker having a pair of interconnected longitudinally-extending members each rotatably connected to an associated handle such that the handles are rotatable between handle erected and handle folded positions;
a leg assembly having a pair of interconnected longitudinally-extending support members each rotatably connected to the kicker and rotatable between leg erected and leg folded positions;
locking means for locking the handles in the erected position;
at least one frame support member each rotatably connected to one handle and to the leg assembly, such that rotation of the connected handle causes the leg assembly to rotate relative to the wheel mounting assembly and locking the handle in the handle erected position causes the leg assembly to lock in the leg erected position;
a wheel rotatably mounted to the wheel mounting assembly; and
a foldable container mounted to the frame such that the container is erected when the leg assembly is in the leg erected position, and folded when the leg assembly is in the leg folded position.

2. The wheelbarrow of claim 1 wherein the locking means comprise
a pair of hinging plates each respectively mounted to one of the handles and one of the kicker members, the hinging plates each having slots that align when the handle is in the handle erected position; and
a lockout member engagable with the aligned slots to lock the plates in place.

3. The wheelbarrow of claim 1 wherein the container is connected at a front end to the leg members and at a rear end to at least one handle such that rotation of the handles between the handle erected and folded positions cause the container to move between container erected and folded positions.

4. The wheelbarrow of claim 3 wherein the longitudinally-extending kicker members are interconnected by a pair of transversely-extending members rotatably connected together such that the wheel mounting assembly is rotatable between a laterally erected position and a laterally folded position.

5. The wheelbarrow of claim 4 wherein the leg longitudinally-extending leg members are interconnected by a pair of transversely-extending members rotatably connected together such that the leg assembly is rotatable between a laterally erected position and a laterally folded position.

6. The wheelbarrow of claim 5 wherein the handles and kicker members are rotatably connected by a pair of hinging devices, each hinging device comprising a pair of hinging plates each mounted to a respective handle and kicker member and rotatably connected to each other, the two hinging plates each having slots that align when the handle is in the erected position, and each hinging device further comprising a lockout member engagable with the slots to lock the associated handle in the handle erected position.

7. The wheelbarrow of claim 6 further comprising a transverse stiffener having rotatably interconnected left and right portions each rotatably connected to an associated handle and rotatably connected to each other, such that the stiffener is rotatable between a transversely-extending erected position that moves the wheel mounting and leg assemblies into the laterally erected positions, and a folded position that moves the wheel mounting and leg assemblies into the laterally folded positions.

8. The wheelbarrow of claim 7 wherein the lock-out member for each handle hinging device is attached to a location on the stiffener that causes the lockout member to engage the associated handle hinging device when the stiffener is in its erected position, and to disengage the associated handle hinging device when the stiffener is in its folded position.

9. A foldable hand cart comprising:
a frame comprising
a wheel mounting assembly having a handle portion with a pair of interconnected longitudinally-extending members and a wheel mounting portion with a pair of interconnected longitudinally extending members, each wheel mounting member rotatably connected to an associated handle member such that the handle portion is rotatable between handle erected and handle folded positions;
a leg assembly having a pair of interconnected longitudinally-extending support members each rotatably connected to the wheel mounting portion and rotatable between leg erected and leg folded positions;
locking means for locking the handle portion in the erected position;
at least one frame support member each rotatably connected to handle portion and to the leg assembly, such that rotation of the handle portion causes the leg assembly to rotate relative to the wheel mounting assembly and locking the handle portion in the handle erected position causes the leg assembly to lock in the leg erected position;
a pair of wheels rotatably mounted to the wheel mounting portion; and
a foldable container mounted to the frame such that the container is erected when the leg assembly is in the leg erected position, and folded when the leg assembly is in the leg folded position.

10. The hand cart of claim 9 wherein the locking means comprise
a pair of hinging plates each respectively mounted to one of the handles and one of the kicker members, the hinging plates each having slots that align when the handle is in the handle erected position; and
a lockout member engagable with the aligned slots to lock the plates in place.

11. The hand cart of claim 9 wherein the container is connected at a front end to the leg members and at a rear end to the handle portion such that rotation of the handle portion between the handle erected and folded positions causes the container to move between container erected and folded positions.
